(19) United States
(12) Patent Application Publication
(10) Pub. No.: US 2020/0320472 A1
(43) Pub. Date: Oct. 8, 2020

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Zekai QIU, Nisshin-shi (JP); Akie SAKIYAMA, Toyota-shi (JP); Yusuke TAKEUCHI, Miyoshi-shi (JP); Jun HIOKI, Nagakute-shi (JP); Shinji SASSA, Ama-shi (JP); Hiromitsu FUJII, Kariya-shi (JP); Keita TERUUCHI, Toyota-shi (JP)

(73) Assignee: TOYOTA JIDOSHA KABUSHIKI KAISHA, Toyota-shi (JP)

(21) Appl. No.: 16/802,650

(22) Filed: Feb. 27, 2020

(30) Foreign Application Priority Data
Apr. 3, 2019 (JP) 2019-071163

(51) Int. Cl. G06Q 10/08

(52) U.S. Cl. CPC G06Q 10/0832; G06Q 10/0833; G06Q 10/0835

(57) ABSTRACT

An information processing apparatus includes a controller configured to determine to pack a plurality of first packages, of which the recipients satisfy a predetermined condition, together to obtain a second package and deliver the second package, to determine a representative, who undertakes to receive the second package as a representative and to hand over the first packages to the recipients respectively, from users satisfying the predetermined condition, to make a request for delivery of the second package to the representative, to receive notification indicating that delivery of the first packages is finished from a user terminal of the representative, and to give an incentive at least to the representative in a case where the notification indicating that the delivery is finished is received.

### INCORPORATION BY REFERENCE

The disclosure of Japanese Patent Application No. 2019-071163 filed on Apr. 3, 2019 including the specification, drawings and abstract is incorporated herein by reference in its entirety.

### BACKGROUND

### 1. Technical Field

The disclosure relates to an information processing apparatus and an information processing method.

### 2. Description of Related Art

A technique in which an autonomous driving vehicle delivers a package to a delivery box on a delivery destination has been proposed (for example, Japanese Unexamined Patent Application Publication No. 2018-177439 (JP 2018-177439 A)).

### SUMMARY

However, for example, a packing material may occupy a larger volume in a box storing a package or the size of a box storing a package may be larger than the size of the package such that a surplus space is generated. In addition, in many cases, delivery is performed for each order unless otherwise specified. Therefore, for example, even in a case where the addresses of delivery destinations of a plurality of ordered products are the same as each other or adjacent to each other, delivery is performed for each of the products.

The disclosure provides an information processing apparatus and an information processing method with which it is possible to improve delivery efficiency.

A first aspect of the disclosure relates to an information processing apparatus including a controller. The controller is configured to determine to pack a plurality of first packages, of which the recipients satisfy a predetermined condition, together to obtain a second package and deliver the second package, to determine a representative, who undertakes to receive the second package as a representative and to hand over the first packages to the recipients respectively, from users satisfying the predetermined condition, to make a request for delivery of the second package to the representative, to receive notification indicating that delivery of the first packages is finished from a user terminal of the representative, and to give an incentive at least to the representative in a case where the notification indicating that the delivery is finished is received.

A second aspect of the disclosure relates to an information processing method. The information processing method includes determining to pack a plurality of first packages, of which the recipients satisfy a predetermined condition, together to obtain a second package and deliver the second package, determining a representative, who undertakes to receive the second package as a representative and to hand over the first packages to the recipients respectively, from users satisfying the predetermined condition, making a request for delivery of the second package to the representative, receiving notification indicating that delivery of the first packages is finished from a user terminal of the representative, and giving an incentive at least to the representative in a case where the notification indicating that the delivery is finished is received.

With the information processing apparatus and the information processing method disclosed, it is possible to achieve an improvement in delivery efficiency.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of a system configuration of a delivery system according to a first embodiment;

FIG. 2 is a diagram illustrating an example of a hardware configuration of a delivery starting point server;

FIG. 3 is a diagram illustrating an example of the functional configuration of the delivery starting point server;

FIG. 4 is an example of a user information management table of the delivery starting point server;

FIG. 5 is an example of a user group information management table of the delivery starting point server;

FIG. 6 is an example of a package information management table of the delivery starting point server;

FIG. 7 is an example of a delivery information management table of the delivery starting point server;

FIG. 8 is an example of a flowchart of a shipment process in batch delivery of the delivery starting point server;

FIG. 9 is an example of a flowchart of a process at the time batch delivery of the delivery starting point server; and

FIG. 10 is a diagram illustrating an example of a processing sequence of batch delivery in the delivery system.

### DETAILED DESCRIPTION OF EMBODIMENTS

A first aspect of the disclosure relates to an information processing apparatus including a controller. The controller is configured to determine to pack a plurality of first packages, of which the recipients satisfy a predetermined condition, together to obtain a second package and deliver the second package, to determine a representative, who undertakes to receive the second package as a representative and to hand over the first packages to the recipients respectively, from users satisfying the predetermined condition, to make a request for delivery of the second package to the representative, to receive notification indicating that delivery of the first packages is finished from a user terminal of the representative, and to give an incentive at least to the representative in a case where the notification indicating that the delivery is finished is received.

Since the first packages are packed together and are delivered as one second package, a deliverer can finish delivery to be performed the same number of times as the number of the first packages with one time of delivery and thus it is possible to achieve an improvement in delivery efficiency. In addition, even when any of the recipients of the first packages is absent, redelivery is not performed by a deliverer if the representative is not absent. Therefore, it is possible to reduce the number of times of redelivery. In addition, since the first packages are packed together, it is possible to reduce a packing material. In addition, since the incentive is given to the representative, it becomes easier to recruit users who become a representative.

For example, the predetermined condition is a condition that the places of residence of the users including the recipients of the packages are within a predetermined area. In a case where the predetermined area is the inside of the same town or the same multiple dwelling house, there is a high possibility that the representative and the recipients of the first packages know each other or a distance by which the representative or the recipients need to move in order that the first packages are handed over is short and the first packages are handed over smoothly. In addition, the predetermined condition is not limited to a geographical condition and may be a condition that the users including the recipients of the packages are members of a family who live apart. In this case, since the representative and the recipients are members of the family, it is possible to give a sense of safety with respect to a fact that the representative receives the first packages.

In addition, in the information processing apparatus according to the first aspect of the disclosure, the controller may re-select a new representative, who receives the second package as a representative, from the users satisfying the predetermined condition in a case where it is detected that the representative is not able to receive the second package. Accordingly, it is possible to reduce the number of times of redelivery of the second package. In addition, in a case where the predetermined condition is a condition that the places of residence of the users including the recipients of the packages are within the predetermined area, it is possible to limit movement of a deliverer of the second package from the place of residence of the former representative to the new representative to the inside of the predetermined area and thus it is possible to shorten a distance by which the deliverer moves.

In addition, in the information processing apparatus according to the first aspect of the disclosure, the controller may transmit a reminder to the user terminal of the representative in a case where it is not detected that the handing over of the first packages included in the second package is finished even after a predetermined time elapses from a time at which the representative receives the second package. Accordingly, it is possible to suppress forgetting to hand over the first packages.

An aspect of the disclosure can also be understood in terms of an information processing method. The information processing method includes determining to pack a plurality of first packages, of which the recipients satisfy a predetermined condition, together to obtain a second package and deliver the second package, determining a representative, who undertakes to receive the second package as a representative and to hand over the first packages to the recipients respectively, from users satisfying the predetermined condition, making a request for delivery of the second package to the representative, receiving notification indicating that delivery of the first packages is finished from a user terminal of the representative, and giving an incentive at least to the representative in a case where the notification indicating that the delivery is finished is received. The above-described technical ideas disclosed in relation to the information processing apparatus can also be applied to the information processing method as long as there is no technical contradiction.

Hereinafter, embodiments of the disclosure will be described based on drawings. The configurations in the following embodiments are merely examples and the disclosure is not limited to the configurations in the embodiments.

### First Embodiment

Outline of System

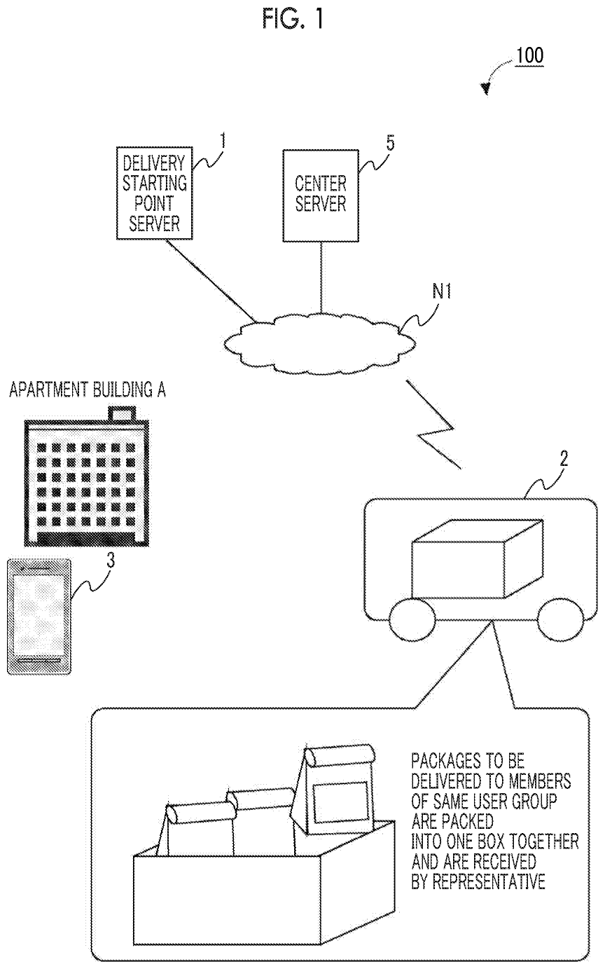

FIG. 1 is a diagram illustrating an example of a system configuration of a delivery system 100 according to a first embodiment. The delivery system 100 is a system in which a plurality of packages, of which the recipient is any of members in a predetermined user group, is packed together and the packages are delivered to a representative who undertakes to receive the packages as a representative, for example. Hereinafter, a job of packing a plurality of packages together and delivering the packages as one package will be referred to as “batch delivery”. In addition, a package obtained by packing a plurality of packages together will be referred to as a “batch package”. A batch package is an example of a “second package”. A package included in the batch package is an example of a “first package”.

The delivery system 100 includes a delivery starting point server 1, vehicles 2, a user terminal 3, and a center server 5. The delivery starting point server 1 is a server that is managed at a delivery starting point from which a package is shipped, examples of the delivery starting point include a store that sells a product by mail. The user terminal 3 is a terminal possessed by a user who is registered in the delivery starting point server 1 as a user so as to receive a service provided by the delivery starting point server 1, for example.

The center server 5 is a server that performs control in relation to delivery in the delivery system 100. The vehicle 2 is a vehicle that performs delivery. In the first embodiment, it is assumed that the vehicle 2 is an electrified autonomous driving vehicle capable of autonomous traveling and unmanned traveling. However, the vehicle 2 may be a vehicle of which a traveling operation is controlled by a driver. Although the delivery system 100 includes a plurality of the vehicles 2, FIG. 1 shows one vehicle 2 for the sake of convenience.

In the first embodiment, the vehicle 2 and the user terminal 3 are connected to a network N1 via a wireless communication network and are connected to the center server 5 or the delivery starting point server 1 through the network N1, for example. The vehicle 2 and the user terminal 3 perform wireless communication conforming to mobile communication standards such as 3rd generation (3G), long term evolution (LTE), LTE-Advanced, and 5th generation (5G) and a wireless LAN standard such as WiFi. The network N1 is, for example, the Internet. It will be assumed that a data communication device that is connected to the network N1 via a wireless communication network and can communicate with the center server 5 is installed in the vehicle 2 in a case where the vehicle 2 is a vehicle of which a traveling operation is controlled by a driver.

The vehicle 2 capable of autonomous traveling and unmanned traveling receives an operation instruction from the center server 5, creates an operation plan, and autonomously travels to a destination according to the operation plan. The vehicle 2 is provided with position information acquisition means. The vehicle 2 acquires position information and transmits the position information to the center server 5 each time a predetermined period elapses.

In the first embodiment, the delivery starting point server 1 determines to pack a plurality of packages, of which the recipients are members of a predetermined user group, together and perform batch delivery. A user group may be set in advance by a user and the delivery starting point server 1 may create a user group with users satisfying a predetermined condition. A group may be composed of residents of the same apartment building, may be composed of users whose places of residence are within a predetermined area, and may be composed of users in a predetermined relationship such as a family.

For example, the packages determined to be subject to the batch delivery are simply packed by a staff at the delivery starting point as shown in FIG. 1 to such an extent that the contents thereof cannot be recognized from the external appearances thereof and are packed into one box in a state where slips indicating that the delivery destinations are the places of residence of the recipients are attached thereto. The box with the packages accommodated therein is a batch package. The slip indicating that the delivery destination is the place of residence of a representative is attached to the batch package. The representative is determined by the delivery starting point server 1. The representative is determined from members of the user group. It does not matter whether or not the representative is the recipient of a package included in the batch package.

The delivery starting point server 1 transmits, to the center server 5, a request for delivery of the batch package. When the center server 5 receives the delivery request, the center server 5 determines the vehicle 2 for delivery and transmits a delivery command to the vehicle 2 for delivery. Accordingly, the vehicle 2 picks up the batch package and delivers the batch package to the representative. Accordingly, the vehicle 2 can finish delivery of the packages by one time of delivery and it is possible to improve delivery efficiency. In addition, it is possible to reduce consumption of a packing material such as a box for protecting each of the packages from an external shock at the time of delivery.

The delivery starting point server 1 transmits notification about the batch delivery to the user terminal 3 of the representative and the user terminals 3 of the recipients of packages included in the batch package. Accordingly, the representative and the recipients of the packages included in the batch package recognize that the packages will be delivered to the place of residence of the representative.

When the representative receives the batch package, the packages are respectively handed over to the recipients of the packages from the representative with the representative delivering the packages to the places of residence of the recipients of the packages respectively or the recipients of the packages going to the place of residence of the representative so as to receive the packages. When all of the packages included in the batch package are handed over, the representative causes the user terminal 3 to transmit notification indicating that the batch delivery is finished to the delivery starting point server 1. When the delivery starting point server 1 receives the notification indicating that the batch delivery is finished from the user terminal 3 of the representative, the delivery starting point server 1 gives an incentive to the representative. The incentive is, for example, points or a coupon that can be used for a service provided by a system of the delivery starting point or a business partner, points that can be exchanged for cash, or the like.

In addition, in the first embodiment, when the delivery starting point server 1 is notified by the vehicle 2 that the representative is absent through the center server 5, the delivery starting point server 1 re-selects a representative and transmits, to the center server 5, a request for delivery of the batch package to the new representative. The new representative is selected from, for example, the members of the same user group. Accordingly, the batch package is delivered to the place of residence of the new representative.

In a case where the user group is composed of members whose places of residence are within a predetermined area, the vehicle 2 can deliver the batch package to the new representative without a change and it is possible to shorten a distance by which the vehicle 2 moves to hand over the batch package to the new representative. In addition, in a case where both of the former representative and the new representative are residents of the same apartment building, the vehicle 2 does not need to move to hand over the batch package to the new representative. Accordingly, it is possible to reduce a possibility that the vehicle 2 brings the batch package back once and delivers the batch package again at a later date.

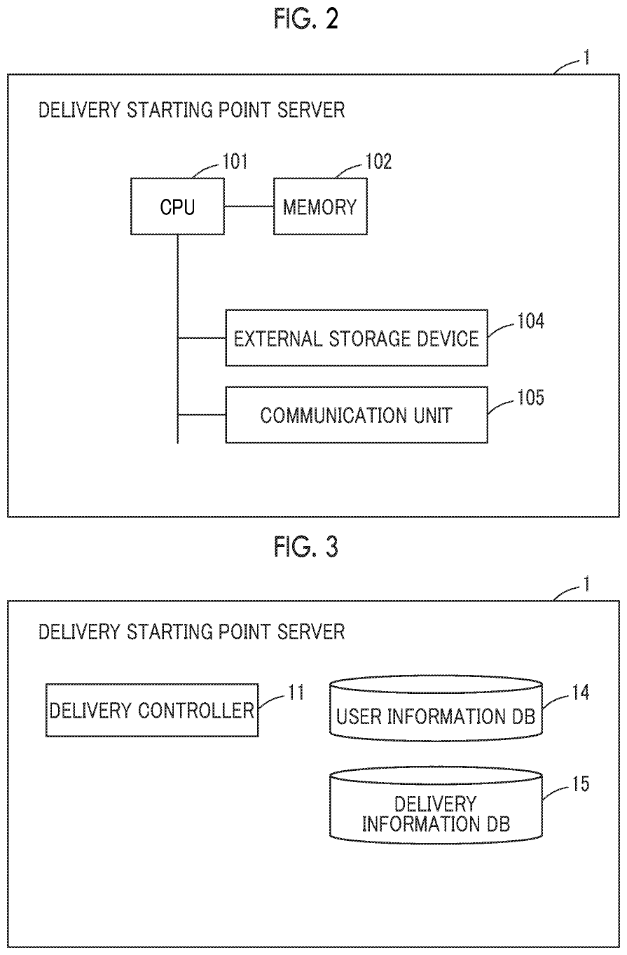

FIG. 2 is a diagram illustrating an example of a hardware configuration of the delivery starting point server 1. The delivery starting point server 1 includes a CPU 101, a memory 102, an external storage device 104, and a communication unit 105. The CPU 101 executes a computer program that is deployed in the memory 102 to be executable and performs processing as the delivery starting point server 1.

The memory 102 stores the computer program to be executed by the CPU 101, data to be processed by the CPU 101, or the like. The memory 102 is a dynamic random access memory (DRAM), a static random access memory (SRAM), a read only memory (ROM), or the like. The external storage device 104 is a non-volatile storage device and is a solid state drive (SSD), a hard disk drive, or the like.

The communication unit 105 is connected to, for example, a public communication line network through a LAN and communicates with various servers on the network N1, the user terminal 3, or the like through the public communication line network. Note that, the hardware configuration of the delivery starting point server 1 is not limited to that shown in FIG. 2 and addition or substitution can be appropriately made depending on an embodiment.

Note that, the vehicle 2, the user terminal 3, and the center server 5 are provided with a computer provided with a CPU, a memory, an external storage device, and a communication unit as with the delivery starting point server 1. The vehicle 2, the user terminal 3, and the center server 5 are further provided with constituent elements such as a display, a microphone, and a speaker according to each embodiment.

FIG. 3 is a diagram illustrating an example of the functional configuration of the delivery starting point server 1. The delivery starting point server 1 functions as each unit shown in FIG. 3 according to the computer program in the memory 102. The delivery starting point server 1 is provided with a delivery controller 11, a user information database (DB) 14, and a delivery information DB 15 as functional constituent elements, for example.

The delivery controller 11 performs control in relation to delivery of a package. More specifically, in a case where the delivery controller 11 detects that there is a plurality of packages of which the recipient is any of members of a predetermined user group and in a case where the delivery controller 11 detects that there is a plurality of packages satisfying conditions for batch delivery, the delivery controller 11 determines to perform batch delivery of the packages. The conditions for batch delivery include, for example, a geographical condition such as a condition that the delivery destinations are the same building and a condition that the addresses of the delivery destinations are within a predetermined area and a human condition such as a condition that batch delivery has been approved by the recipients.

Next, the delivery controller 11 creates package groups corresponding to batch packages, with respect to a plurality of packages of which the recipients are members of the same user group or a plurality of packages satisfying the same condition for batch delivery. This is because there is a limit on the number of packages that can be delivered by one time of batch delivery depending on an upper limit set for the number of packages constituting a batch package, the size of a box to be used for a batch package, or the like, for example. For example, in a case where there is an upper limit set for the number of packages constituting a batch package, the delivery controller 11 creates package groups with respect to the packages of which the recipients are members of the same user group or the packages satisfying the same condition for batch delivery such that the number of packages included in one package group does not exceed the upper limit. For example, in a case where there is a size set for a box to be used for batch delivery, the delivery controller 11 creates package groups with respect to the packages of which the recipients are members of the same user group or the packages satisfying the same condition for batch delivery such that packages are accommodated in one box.

Next, the delivery controller 11 determines a representative for each package group. A representative is selected from users who has performed setting to approve to become a representative, for example. In addition, a representative may be selected from users who have performed setting to approve to become a representative and are the recipients of packages included in a package group.

When the package groups and the representatives are determined, packages included in each package group is packed into one box together by a staff to form a batch package. When a batch package is ready to be shipped, the delivery controller 11 transmits, to the center server 5, a request for delivery of the batch package. Along with the request for delivery of the batch package, user information of the representative and information about the packages are also transmitted. User information includes the name of a user, the address of the place of residence of the user, and the like. In addition, the delivery controller 11 transmits notification about batch delivery to the user terminals 3 of the recipients of the packages included in the batch package and the user terminal 3 of the representative. Notification from the delivery starting point server 1 to the user terminal 3 is transmitted by means of an electronic mail, push delivery, or the like.

The content of notification about batch delivery to be transmitted to a representative and the content of notification about batch delivery to be transmitted to the recipients of packages included in a batch package may be different from each other. For example, notification about batch delivery to be transmitted to a representative includes information indicating that batch delivery in which a corresponding user is the representative will be performed and user information of the recipients of packages included in a batch package. User information includes the name of a user, the address of the place of residence of the user, and the like. In addition, notification about batch delivery to be transmitted to a representative may include information about packages included in a batch package. Information about a package is, for example, information about whether or not the package needs to be refrigerated, information about whether or not the package needs to be frozen, the size of the package, information about whether or not the package is not to be turned upside down, or the like. Notification about batch delivery to be transmitted to the recipients of packages included in a batch package include, user information of the representative, information about the packages to the recipients, and the like.

Next, in a case where the delivery controller 11 detects that a representative is absent from the place of residence of the representative, which is the delivery destination of a batch package, while the batch package is being delivered, the delivery controller 11 re-selects a new representative. Detection of the absence of a representative is performed by receiving notification from the vehicle 2 via the center server 5, for example. In addition, in a case where the vehicle 2 is an unmanned autonomous driving vehicle and the handing over of a package is not finished even after a predetermined time elapses at a delivery destination, the vehicle 2 detects that a recipient is absent from the delivery destination and notifies the center server 5 of the absence of the recipient.

The new representative may be selected from users who are the recipients of packages included in the batch package and who have approved to become a representative. In addition, for example, the new representative may be a user who is a member whose place of residence is closest to the place of residence of the former representative in the same user group and who has approved to become a representative.

The delivery controller 11 transmits, to the center server 5, a destination change request for changing the destination of corresponding batch delivery to the new representative. The center server 5 notifies the vehicle 2 performing the batch delivery that the delivery destination has been changed and thus the vehicle 2 starts to move to the place of residence of the new representative.

When a batch package is handed over to a representative, for example, the vehicle 2 transmits notification indicating that delivery of the batch package is finished to the center server 5. The center server 5 transfers the notification indicating that the delivery of the batch package is finished to the delivery starting point server 1. When the representative receives the batch package, the representative performs an action for handing over packages included in the batch package to respective recipients and when all of the packages included in the batch package are handed over to the recipients, the representative causes the user terminal 3 to transmit notification indicating that the batch delivery is finished to the delivery starting point server 1. The notification indicating that the batch delivery is finished, which is transmitted from the user terminal 3 to the delivery starting point server 1 is transmitted by means of web communication such as HTTP.

After a batch package is handed over to a representative, the delivery controller 11 stands by to receive notification indicating that batch delivery is finished, from the user terminal 3 of the representative. For example, in a case where the delivery controller 11 does not receive notification indicating that batch delivery is finished from the user terminal 3 of a representative even after a predetermined time elapses from a time at which notification indicating that delivery of a batch package is finished is received from the vehicle 2 via the center server 5, the delivery controller 11 transmits a reminder to the user terminal 3 of the representative. A time until transmission of the reminder can be randomly set by a manager of the delivery starting point server 1 in units of hours, in units of days, or in units of weeks, for example.

In a case where notification indicating that batch delivery is finished is received from the user terminal 3 of a representative, the delivery controller 11 gives an incentive to the representative. The incentive may be given uniformly regardless of the number of packages included in a batch package and the larger incentive may be given as the number of packages included in a batch package increases.

The user information DB 14 and the delivery information DB 15 are created in a storage region of the external storage device 104 of the delivery starting point server 1, for example. The user information DB 14 and the delivery information DB 15 are relational databases. The user information DB 14 stores information about users who want to receive a service provided by the delivery starting point server 1. The delivery information DB 15 stores information about delivery. Details of information stored in each DB will be described later.

Note that, any of the functional constituent elements of the delivery starting point server 1 or a part of processes thereof may be executed by another computer connected to a network. In addition, a series of processes performed in the delivery starting point server 1 may be performed by means of a hardware and may be performed by means of software.

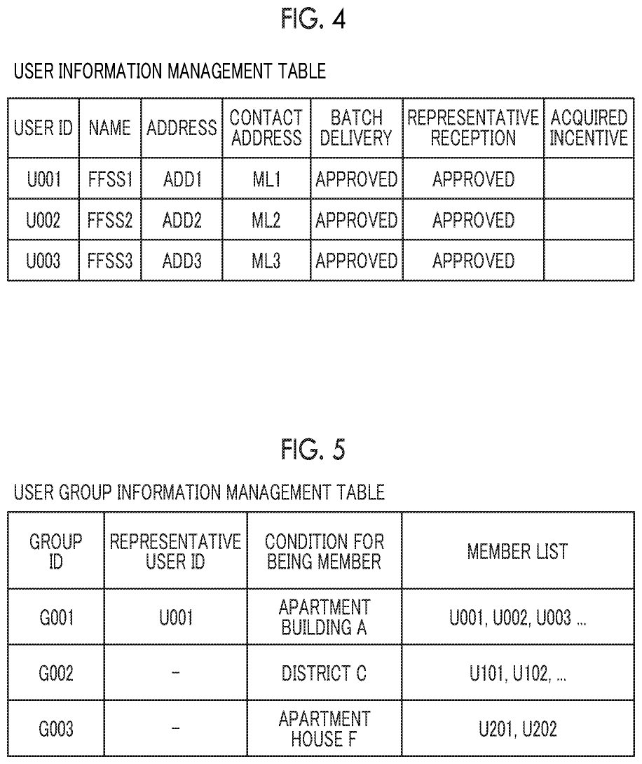

FIG. 4 is an example of a user information management table of the delivery starting point server 1. The user information management table is stored in the user information DB 14. The information about users who want to receive a service provided by the delivery starting point server 1 is stored in the user information management table.

The user information management table as shown in FIG. 4 includes items for user IDs, names, addresses, contact addresses, batch delivery, representative reception, and acquired incentives. In an item for a user ID, identification information of a user is stored. In an item for a name, the name a user is stored. In an item for an address, the address of the place of residence of a user is stored. The address of a user may become the address of a delivery destination. In an item for a contact address, the telephone number, the electronic mail address, or the like of a user is stored. Information included in the items for the contact addresses is used as the destination of notification from the delivery starting point server 1 such as notification about batch delivery.

In an item for batch delivery, information indicating whether or not a corresponding user has approved batch delivery is stored. Examples of information indicating whether or not a user has approved batch delivery include a flag or a code. However, in FIG. 4, texts of “approved” in the items for batch delivery are shown as information indicating that the users approve batch delivery, for the sake of convenience.

In an item for representative reception, information indicating whether or not a corresponding user has approved to become a representative in batch delivery is stored. Examples of information indicating whether or not a user has approved to become a representative in batch delivery include a flag or a code. However, in FIG. 4, texts of “approved” in the items for representative reception are shown as information indicating that the users have approved to become a representative in batch delivery, for the sake of convenience.

In an item for an acquired incentive, information about an incentive acquired by a corresponding user is stored. Note that, information held in the user information management table is not limited to that shown in FIG. 4 and can be appropriately changed depending on an embodiment.

FIG. 5 is an example of a user group information management table of the delivery starting point server 1. The user group information management table is stored in the user information DB 14. The user group information management table is a table that holds information about a user group set by a user. For example, a user can set a user group newly by himself or herself and can belong to a group selected from existing user groups. In addition, a user group may be prepared in advance by the delivery starting point server 1.

The user group information management table as shown in FIG. 5 includes items for group IDs, representative user IDs, conditions for being a member, and member lists. In an item for a group ID, identification information of a user group is stored. In an item for a representative user ID, identification information of a user, who is the representative of a corresponding group set by a user, is stored. Note that, the way in which a representative is set by a user is not particularly limited. In the first embodiment, in a case where a value is set for an item for a representative user ID, the delivery controller 11 selects a user indicated by the value in the item for the representative user ID as the representative of a corresponding user group in batch delivery.

In an item for a condition for being a member, a condition for being a member of a corresponding user group is stored. As a condition for being a member, for example, a condition relating to a place of residence is set. For example, “apartment building A” in an item for a condition for being a member shown in FIG. 5 indicates that a condition that the place of residence is the apartment building A has been set. For example, “district C” in an item for a condition for being a member shown in FIG. 5 indicates that a condition that the address of the place of residence is within the district C has been set. In an item for a member list, identification information of users, who are members of a corresponding user group, is stored. One user can belong to a plurality of user groups. Note that, information held in the user group information management table is not limited to that shown in FIG. 5 and can be appropriately changed depending on an embodiment. A condition for being a member is an example of the “predetermined condition”.

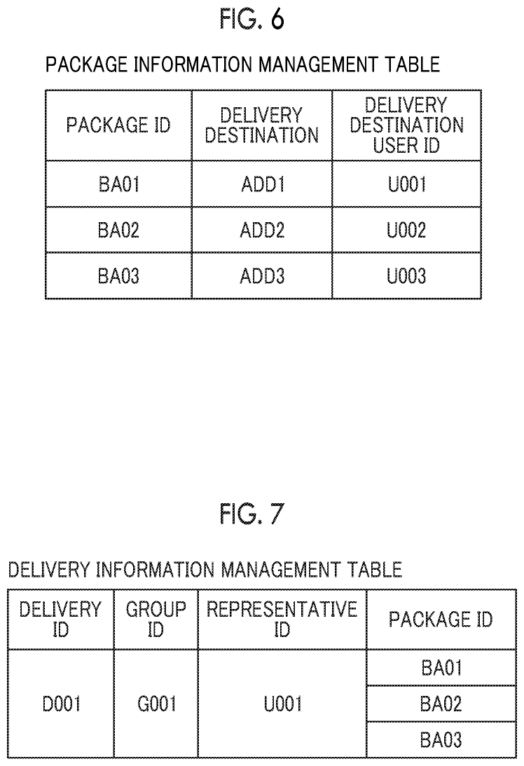

FIG. 6 is an example of a package information management table of the delivery starting point server 1. The package information management table is stored in the delivery information DB 15. The package information management table is a table that holds information relating to packages.

The package information management table as shown in FIG. 6 includes items for package IDs, delivery destinations, and delivery destination user IDs. In an item for a package ID, identification information of a package is stored. In an item for a delivery destination, the address of the delivery destination of a corresponding package is stored. In an item for a delivery destination user ID, identification information of a user who is the recipient of a corresponding package is stored. In a case where a recipient as a package delivery destination is not registered in the delivery starting point server 1 as a user, an item for a delivery destination user ID becomes empty. Note that, in the first embodiment, a package of which an item for a delivery destination user ID is empty is excluded from targets of batch delivery because batch delivery is to be applied to a recipient who is registered as a user. Note that, information held in the package information management table is not limited to that shown in FIG. 6 and can be appropriately changed depending on an embodiment.

FIG. 7 is an example of a delivery information management table of the delivery starting point server 1. The delivery information management table is held in the delivery information DB 15. The delivery information management table is a table that holds information relating to shipment of a package from the delivery starting point server 1.

The delivery information management table as shown in FIG. 7 includes items for delivery IDs, group IDs, representative IDs, and package IDs. In an item for a delivery ID, delivery identification information is stored. Delivery identification information may be shared with the center server 5. In the case of batch delivery as well, there is one piece of delivery identification information.

In an item for a group ID, identification information of a user group is stored in a case where corresponding delivery is batch delivery. In a case where corresponding delivery is not batch delivery, an item for a group ID becomes empty. In an item for a representative ID, identification information of a user, who is the representative of corresponding batch delivery, is stored. When the representative of corresponding package group is selected by the delivery controller 11, a value is input into an item for a representative ID.

In an item for a package ID, identification information of a package is stored. Note that, information held in the delivery information management table is not limited to that shown in FIG. 7 and can be appropriately changed depending on an embodiment.

Flow of Process

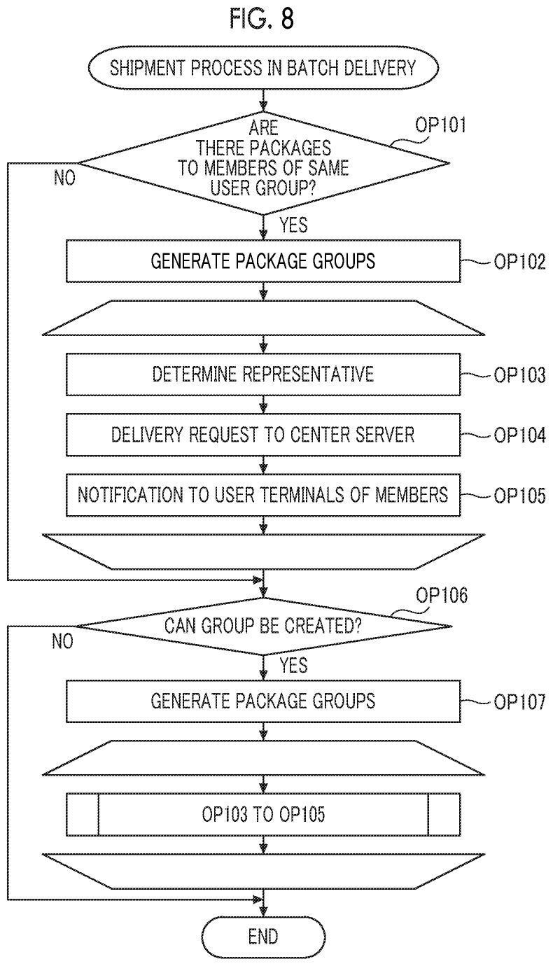

FIG. 8 is an example of a flowchart of a shipment process in batch delivery of the delivery starting point server 1. The process shown in FIG. 8 is performed as a batch process at a predetermined time. For example, the process is performed one time in a day or one time in half a day. However, the disclosure is not limited thereto. The process shown in FIG. 8 may be started when a manager of the delivery starting point server 1 issues an instruction to start the process. Although the process shown in FIG. 8 is performed by the CPU 101 of the delivery starting point server 1, the following description will be made as if the process is performed by a functional constituent element. The same applies to flowcharts after FIG. 8.

In OP 101, the delivery controller 11 determines whether there is a plurality of packages of which the recipient is any of members of the same user group. The process in OP 101 is performed based on the user group information management table (FIG. 5) and the package information management table (FIG. 6), for example. In a case where there is a plurality of packages of which the recipient is any of members of the same user group (OP 101: YES), the process proceeds to OP 102. In a case where there is no plurality of packages of which the recipient is any of members of the same user group (OP 101: NO), the process proceeds to OP 107.

In OP 102, the delivery controller 11 creates package groups of the packages of which the recipient is any of members of the user group detected in OP 101, for each user group. The process in OP 102 is performed based on the user group information management table (FIG. 5) and the package information management table (FIG. 6), for example. A package group may be composed of packages of which the addresses of the delivery destinations are close to each other, for example. Since one package group corresponds to one time of batch delivery, the delivery controller 11 registers information about the package groups in the delivery information management table (FIG. 7).

Processes in OP 103 to OP 106 are repeated for each of the package groups created in OP 102. In OP 103, the delivery controller 11 determines the representative of a processing target package group. The process in OP 103 is performed based on the user information management table (FIG. 4), the user group information management table (FIG. 5), and the package information management table (FIG. 6), for example. The representative of a package group may be selected from the recipients of packages included in the package group and may be selected from members of a user group corresponding to the package group. In addition, in the first embodiment, in a case where the representative of a user group corresponding to a corresponding package group is set in the user group information management table (FIG. 5), a user set as the representative is selected as the representative. Note that, in any case, a user who can become a representative is a user about which information indicating that becoming a representative has been approved is stored in an item for representative reception in the user information management table (FIG. 4). When the representative is determined, the delivery controller 11 stores the user ID of the representative in an item for a representative ID corresponding to corresponding batch delivery in the delivery information management table (FIG. 7), for example.

In OP 104, the delivery controller 11 transmits, to the center server 5, a request for delivery of a batch package corresponding to the processing target package group. Along with the request for delivery, the address of the place of residence of the representative of the processing target package group and information about the batch package (size or like) are also transmitted as destination information.

In OP 105, the delivery controller 11 transmits notification about the batch delivery to the user terminals 3 of the recipients of packages included in the package group and the user terminal 3 of the representative. When the processes in OP 103 to OP 105 are finished for all of the package groups created in OP 102, the process proceeds to OP 106.

In OP 106, the delivery controller 11 determines whether a package group can be created with respect to remaining packages which are not determined to be subject to batch delivery. The process in OP 106 is performed based on the user information management table (FIG. 4) and the package information management table (FIG. 6), for example. The result of the determination in OP 106 becomes positive in a case where there is a plurality of packages of which the recipients have performed setting to approve batch delivery and that satisfies a predetermined condition. The predetermined condition is, for example, a condition that the destinations of packages are within the same building or the same town. However, the predetermined condition at the time of creation of a package group is not limited thereto. In a case where it is possible to create a package group with respect to remaining packages which are not determined to be subject to batch delivery (OP 106: YES), the process proceeds to OP 107. In a case where it is not possible to create a package group with respect to remaining packages which are not determined to be subject to batch delivery (OP 106: NO), the process shown in FIG. 8 is terminated.

In OP 107, the delivery controller 11 creates package groups which can be created with respect to remaining packages which are not determined to be subject to batch delivery. The process in OP 107 is performed based on the user information management table (FIG. 4) and the package information management table (FIG. 6), for example. In OP 107, the package groups created such that a package group is composed of a plurality of packages of which the recipients have performed setting to approve batch delivery and that satisfies the predetermined condition. In addition, in OP 107, a package group is created such that a user who has performed setting to approve to become a representative is included.

Thereafter, the same process as in OP 103 to OP 105 are performed for each of the package groups created in OP 107. However, as the representative of a package group created in OP 107, a user who is the recipient of a package included in the package group and who has performed setting to approve to become a representative is selected. This is because no user group is formed by the recipients of packages included in the package groups created in the OP 107. When the same processes as in OP 103 to OP 105 are finished for all of the package groups created in OP 107, the process shown in FIG. 8 is terminated.

Note that, in OP 107, the delivery controller 11 creates the package groups without depending on existing user groups. However, creating package groups has the same meaning as creating user groups of which members are the recipients of packages included in the package groups.

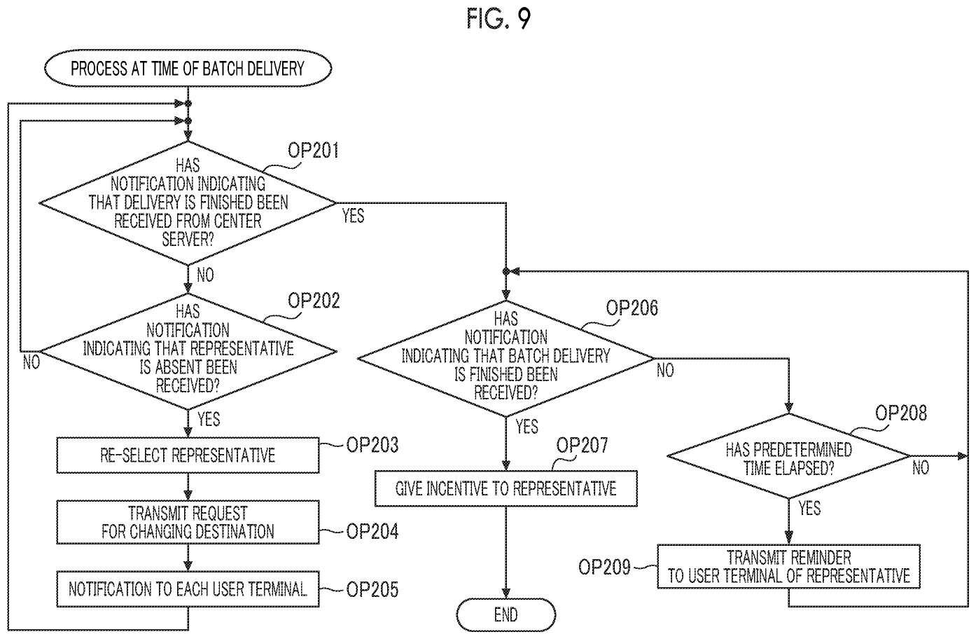

FIG. 9 is an example of a flowchart of a process at the time batch delivery of the delivery starting point server 1. The process shown in FIG. 9 is started when a request for delivery of one batch package is transmitted.

In OP 201, the delivery controller 11 determines whether or not notification indicating that delivery is finished has been received from the vehicle 2 through the center server 5 with respect to processing target batch delivery. Along with the notification indicating that delivery is finished, identification information about target delivery is also received. Hereinafter, it will be assumed that batch package and batch delivery in FIG. 9 mean processing target batch package and processing target batch delivery. In a case where the notification indicating that the delivery is finished has been received (OP 201: YES), the process proceeds to OP 206. In a case where the notification indicating that the delivery is finished has not been received (OP 201: NO), the process proceeds to OP 202.

In OP 202, the delivery controller 11 determines whether or not notification indicating that the representative of the batch delivery is absent has been received from the vehicle 2 through the center server 5. In a case where the notification indicating that the representative of the batch delivery is absent has been received (OP 202: YES), the process proceeds to OP 203. In a case where the notification indicating that the representative of the batch delivery is absent has not been received (OP 202: NO), the process proceeds to OP 201.

The processes in OP 203 to OP 205 are processes performed in a case where the notification indicating that the representative of the batch delivery is absent is received. In OP 203, the delivery controller 11 re-selects a substitute representative since the representative of the batch delivery is absent. The process in OP 203 is performed based on the user information management table (FIG. 4), the user group information management table (FIG. 5), the package information management table (FIG. 6), and the delivery information management table (FIG. 7), for example. The new representative is selected from users who have performed setting to approve to become a representative and are the recipients of packages included in the batch package. However, the disclosure is not limited thereto. The new representative may be selected from users who have performed setting to approve to become a representative and who are members of a user group corresponding to the package group of the batch package even when the users are not the recipients of packages included in the batch package, for example. Note that, in a case where there is a plurality of corresponding users, for example, a user whose place of residence is closest to the place of residence of the former representative may be selected as the new representative. This is because the place of residence of the former representative is the current position of the vehicle 2.

In OP 204, the delivery controller 11 transmits, to the center server 5, a request for changing the destination to the place of residence of the new representative. Along with the request for changing the destination, identification information of target batch delivery is also transmitted. When the center server 5 receives the request for changing the destination, the center server 5 transmits the request for changing the destination to the corresponding vehicle 2 and the vehicle 2 starts to move to the place of residence of the new representative, for example. However, the vehicle 2 stands by without moving in a case where the vehicle 2 does not need to move since the place of residence of the former representative and the place of residence of the new representative are in the same building or the like.

In OP 205, the delivery controller 11 transmits, to the user terminal 3 of each of the recipients of packages included in the batch package, the new representative, and the former representative, notification indicating that the representative of the batch delivery has been changed. Along with the notification indicating that the representative of the batch delivery has been changed, for example, identification information of the batch delivery, user information of the former representative, user information of the new representative, or the like are also transmitted. Thereafter, the process proceeds to OP 201.

Processes in OP 206 to OP 209 are processes performed in a case where the notification indicating that the batch delivery is finished is received. In OP 206, the delivery controller 11 determines whether or not notification indicating the batch delivery is finished has been received from the user terminal 3 of the representative. Along with the notification indicating the batch delivery is finished, identification information of delivery is also received. In a case where the notification indicating the batch delivery is finished has been received from the user terminal 3 of the representative (OP 206: YES), the process proceeds to OP 207. In a case where the notification indicating the batch delivery is finished has not been received from the user terminal 3 of the representative (OP 206: NO), the process proceeds to OP 208.

In OP 207, the delivery controller 11 gives an incentive to a user, who is the representative of the batch delivery, since the delivery controller 11 has received the notification indicating that the batch delivery is finished. At this time, the value in an item for an acquired incentive of the user in the user information management table (FIG. 4) is also updated. Thereafter, the process shown in FIG. 9 is terminated.

In OP 208, the delivery controller 11 determines whether or not a predetermined time has elapsed after the notification indicating that the delivery is finished is received from the vehicle 2 through the center server 5. In a case where the predetermined time has not elapsed after the notification indicating that the delivery is finished is received from the vehicle 2 through the center server 5 (OP 208: NO), the process proceeds to OP 206. In a case where the predetermined time has elapsed after the notification indicating that the delivery is finished is received from the vehicle 2 through the center server 5 (OP 208: YES), the process proceeds to OP 209.

In OP 209, the delivery controller 11 transmits a reminder to the user terminal 3 of the representative. The reminder includes a message prompting the representative to hand over packages, for example. Thereafter, the process proceeds to OP 206. In a case where the determination in OP 208 is performed again after OP 209, determination on whether or not the predetermined time has elapsed after transmission of the reminder is performed.

Note that, the processes of the delivery starting point server 1 shown in FIGS. 8 and 9 are merely examples and modification, deletion, substitution, and order modification can be appropriately made depending on an embodiment.

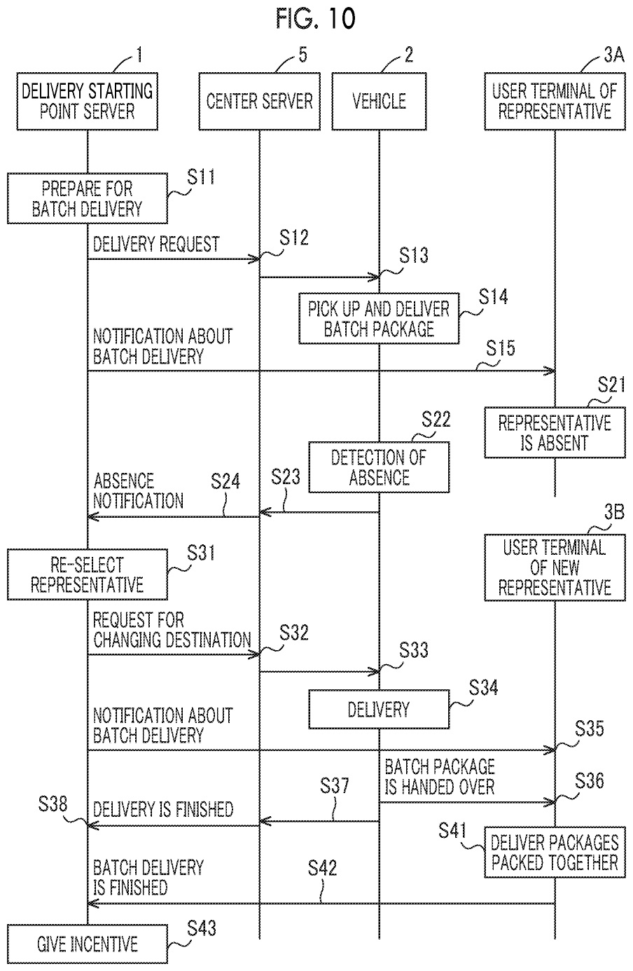

FIG. 10 is a diagram illustrating an example of a processing sequence of batch delivery in the delivery system 100. In S11, the delivery starting point server 1 performs a processing of preparing for batch delivery. The process of preparing for batch delivery is, for example, creation of a package group, determination of the representative, or the like (OP 101 to OP 103 in FIG. 8). Here, it will be assumed that a user A is selected as the representative. In addition, a reference numeral “3A” will be given to a user terminal of the user A. In addition, at a delivery starting point, a batch package is prepared by a staff packing packages included in a package group together.

In S12, the delivery starting point server 1 transmits a request for delivery of the batch package to the center server 5 (OP 104 in FIG. 8). In S13, the center server 5 receives the request for delivery of the batch package from the delivery starting point server 1, determines the vehicle 2 as a vehicle for delivery, and transmits a delivery command for the batch package to the vehicle 2. In S14, the vehicle 2 receives the delivery command from the center server 5, moves to a designated pickup place such that the batch package is loaded thereinto, and starts delivery.

In S15, the delivery starting point server 1 transmits notification about the batch delivery to the user terminals 3 of the recipients of packages included in the batch package and a user terminal 3A of the user A who is the representative (OP 105 in FIG. 8).

It will be assumed that the user A, who is the representative, is absent from the registered place of residence in S21. In S22, the vehicle 2 detects that the representative is absent from the place of residence, which is the delivery destination of the batch package. For example, in a case where the handing over of the packages is not finished even after the vehicle 2 stands by for the predetermined time at the delivery destination, the vehicle 2 detects that the recipient is absent.

In S23, the vehicle 2 transmits absence notification to the center server 5. In S24, the center server 5 receives the absence notification from the vehicle 2 and transfers the absence notification to the delivery starting point server 1.

In S31, the delivery starting point server 1 receives notification indicating that the representative is absent (OP 202 in FIG. 9: YES) and re-selects a representative (OP 203 in FIG. 9). The representative newly selected here will be referred to as a user B and a reference numeral “3B” will be given to a user terminal of the user B. In S32, the delivery starting point server 1 transmits a request for changing the destination to the center server 5 so as to request to change the destination of the batch package to the user B from the user A (OP 204 in FIG. 9). In S33, the center server 5 receives the request for changing the destination and transmits, to the vehicle 2, an instruction to change the delivery destination to the place of residence of the user B and to move. In S34, the vehicle 2 receives the instruction to change the delivery destination to the place of residence of the user B and to move from the center server 5 and delivers the batch package to the place of residence of the user B.

In S35, the delivery starting point server 1 transmits notification about the batch delivery to the user terminals 3 of the recipients of the packages included in the batch package, the user terminal 3A of the user A, who is the former representative, and the user terminal 3B of the user B, who is the new representative (OP 205 in FIG. 9).

In S36, the vehicle 2 arrives at the place of residence of the user B and the batch package is handed over to the user B. In S37, the vehicle 2 transmits notification indicating that the delivery of the batch package is finished to the center server 5. In S38, the center server 5 receives the notification indicating that the delivery of the batch package is finished from the vehicle 2 and transfers the notification to the delivery starting point server 1. The delivery starting point server 1 receives the notification indicating that the delivery of the batch package is finished (OP 201 in FIG. 9: YES).

In S41, the user B finishes handing over the packages included in the batch package by delivering the packages or causing the recipients to come to receive the packages. In S42, the user B causes the user terminal 3B to transmit notification indicating that the batch delivery is finished to the delivery starting point server 1. The delivery starting point server 1 receives the notification indicating that the batch delivery is finished from the user terminal 3B (OP 206 in FIG. 9: YES). In S43, the delivery starting point server 1 gives an incentive to the user B (OP 207 in FIG. 9).

For example, in a case where the user A and the user B are members of a user group satisfying a condition for being a member that the places of residence are within the same district, the vehicle 2 is restrained from to moving out of the district even when the representative is changed from the user A to the user B. In a case where a member closest to the place of residence of a former representative is selected when a new representative is selected at the time of absence of a representative, a distance by which the vehicle 2 moves due to change of a representative can be shortened. In addition, in a case where the places of residence of the user A and the user B are in the same building, movement of vehicle 2 is not caused by change of a representative.

Effect of First Embodiment

In the first embodiment, a plurality of packages of which the recipient is any of members of the same user group is packed together to obtain one batch package and the batch package is delivered to a representative. Accordingly, it is possible to perform a plurality of delivery jobs with one time of delivery and there is an improvement in delivery efficiency. In addition, it is possible to reduce a package packing material. In addition, even in a case where a surplus space in a storage box is generated if one package is stored, it is possible to effectively utilize the space in the box by packing other packages together with the one package. In addition, for a deliverer, it is possible to compensate a shortage of manpower.

In addition, an incentive is given to a representative. Accordingly, it is possible to give a reward for a burden that a representative bears since the representative hands over packages and thus it becomes easier to recruit users who approve to become a representative.

In addition, in the first embodiment, in a case where a representative is absent, a new representative is selected and a batch package is delivered to the place of residence of the new representative. Accordingly, it is possible to suppress occurrence of redelivery of a batch package. In addition, in a case where the places of residence of a former representative and a new representative are in the same building or the same district, the movement of a delivery vehicle can be reduced.

In addition, in the first embodiment, in a case where notification indicating that batch delivery is finished is not received from the user terminal 3 of a representative even after a predetermined time elapses after a batch package is handed over to the representative, a reminder is transmitted from the delivery starting point server 1 to the user terminal 3 of the representative. Accordingly, it is possible to restrain each package included in the batch package from being handed over by the representative late.

In addition, in the first embodiment, even in the case of packages of users for whom no user group has been set, when a predetermined condition is satisfied, the delivery starting point server 1 creates a package group of a plurality of packages satisfying the predetermined condition and batch delivery is performed. Accordingly, it is possible to increase the number of packages delivered by means of batch delivery and thus it is possible to achieve an improvement in delivery efficiency.

### Other Embodiment

The above-described embodiments are merely examples and the disclosure can be implemented with appropriate modifications without departing from the gist of the disclosure.

The processes or means described in the disclosure can be freely combined with each other as long as there is no technical contradiction.

In the first embodiment, an incentive is given to the representative of batch delivery. However, in the case of batch delivery, the recipient of each package may go to the place of residence of the representative to receive the package and thus an incentive may be given to the recipient of each package included in a batch package. In this case, the representative may be given a larger incentive than the recipient of each package.

In addition, a process that has been described as a process performed by one device may be divided up and performed by a plurality of devices. Alternatively, a process that has been described as a process performed by different devices may be performed by one device. It is possible to flexibly change with what kind of hardware configuration (server configuration) each function is realized in a computer system.

The disclosure also can be realized when a computer program, in which the functions described in the above-described embodiments are mounted, is supplied to a computer and one or more processors of the computer reads and executes the program. Such a computer program may be provided to a computer via a non-temporal computer-readable storage medium that can be connected to a system bus of the computer and may be provided to the computer via a network. Examples of the non-temporal computer-readable storage medium include any type of disk such as a magnetic disk (floppy (registered trademark) disk, hard disk drive (HDD), or like) and an optical disk (CD-ROM, DVD disk, Blu-ray disk, or like), a read-only memory (ROM), a random access memory (RAM), an EPROM, an EEPROM, a magnetic card, a flash memory, an optical card, and any type of medium suitable for storing electronic commands.

What is claimed is:

1. An information processing apparatus comprising a controller configured to
determine to pack a plurality of first packages, of which recipients satisfy a predetermined condition, together to obtain a second package and deliver the second package,
determine a representative, who undertakes to receive the second package as a representative and to hand over the first packages to the recipients respectively, from users satisfying the predetermined condition,
make a request for delivery of the second package to the representative,
receive notification indicating that delivery of the first packages is finished from a user terminal of the representative, and
give an incentive at least to the representative in a case where the notification indicating that the delivery is finished is received.

2. The information processing apparatus according to claim 1, wherein the controller re-selects a new representative, who receives the second package as a representative, from the users satisfying the predetermined condition in a case where it is detected that the representative is not able to receive the second package.

3. The information processing apparatus according to claim 1, wherein the controller transmits a reminder to the user terminal of the representative in a case where it is not detected that delivery of the first packages included in the second package is finished even after a predetermined time elapses from a time at which the representative receives the second package.

4. The information processing apparatus according to claim 1, wherein the predetermined condition is a condition that places of residence of the users including recipients of packages are within a predetermined area.

5. An information processing method comprising:
determining to pack a plurality of first packages, of which recipients satisfy a predetermined condition, together to obtain a second package and deliver the second package;
determining a representative, who undertakes to receive the second package as a representative and to hand over the first packages to the recipients respectively, from users satisfying the predetermined condition;
making a request for delivery of the second package to the representative;
receiving notification indicating that delivery of the first packages is finished from a user terminal of the representative; and
giving an incentive at least to the representative in a case where the notification indicating that the delivery is finished is received.
